(19) United States
(12) Patent Application Publication
(10) Pub. No.: US 2025/0058674 A1
(43) Pub. Date: Feb. 20, 2025

(54) AUTOMATED MANAGEMENT SYSTEM FOR DUAL-DESIGN BATTERY PACK

(71) Applicant: GM GLOBAL TECHNOLOGY OPERATIONS LLC, Detroit, MI (US)

(72) Inventors: Jun-mo Kang, Ann Arbor, MI (US); Su-Yang Shieh, Clawson, MI (US)

(73) Assignee: GM GLOBAL TECHNOLOGY OPERATIONS LLC, Detroit, MI (US)

(21) Appl. No.: 18/452,073

(22) Filed: Aug. 18, 2023

(51) Int. Cl. B60L 58/18; B60L 50/64; B60L 58/13; H01M 10/42; H02J 7/00

(52) U.S. Cl. CPC B60L 58/18; B60L 50/64; B60L 58/13; H01M 10/425; H02J 7/0063; H02J 7/00712; B60L 2210/10; B60L 2260/26; H01M 4/505; H01M 4/525; H01M 4/5825; H01M 2010/4271; H01M 2220/20; H02J 2207/20

(57) ABSTRACT

A system for managing an energy storage device in an electric vehicle includes a battery pack having an energy module, and a power module connected in parallel to the energy module. The energy module is adapted to generate a first current. At least one DC-to-DC (direct current to direct current) converter is adapted to receive the first current from the energy module and transmit a current, referred to herein as “DC-DC current”, to the power module. The system includes a controller having a processor and tangible, non-transitory memory on which instructions are recorded for automated management of a set of parameters related to the battery pack, subject to a plurality of constraints. The power module is adapted to deliver a second current for powering a load in the electric vehicle. Operation of the electric vehicle is controlled based in part on the set of parameters.

### INTRODUCTION

The present disclosure relates generally to management of an energy storage device in a vehicle. More specifically, the disclosure pertains to a system and method for automated management of a dual-design battery pack. The use of mobile platforms employing a rechargeable energy source, both as an exclusive source of energy and a non-exclusive source of energy, has greatly increased over the last few years. An energy storage device with battery packs may store and release electrochemical energy as needed during a given operating mode. The electrochemical energy may be employed for propulsion, heating or cooling a cabin compartment, powering vehicle accessories and other uses. The various cells in the battery packs may be characterized by different charge states, power, and capacity rates. In a battery pack with a complex structure, management of the various parameters may be challenging.

### SUMMARY

Disclosed herein is a system for managing an energy storage device in an electric vehicle. The system includes a battery pack having an energy module, and a power module connected in parallel to the energy module. The energy module is adapted to generate a first current. At least one DC-to-DC (direct current to direct current) converter is adapted to receive the first current from the energy module and transmit a current, referred to herein as “DC-DC current”, to the power module. The system includes a controller having a processor and tangible, non-transitory memory on which instructions are recorded for automated management of a set of parameters related to the battery pack, subject to a plurality of constraints.

The power module is adapted to deliver a second current for powering a load in the electric vehicle. The energy module is adapted to selectively recharge the power module with a charging current after a predefined event of relatively high power demand. The set of parameters includes the DC-DC current, a first state of charge defined by the energy module, and a second state of charge defined by the power module. Operation of the electric vehicle is controlled based in part on the set of parameters.

The energy module and the power module may have different chemistries. In one embodiment, the energy module includes respective battery cells composed of nickel, cobalt oxide, and manganese. The power module may include the respective battery cells composed of lithium, iron, and phosphate. The electric vehicle may be adapted to undergo a first stage and a second stage. The first stage is associated with an initial acceleration mode and/or take-off mode of the vehicle, while the second stage being associated with a driving mode and/or cruising mode of the vehicle. The energy module may be adapted to recharge the power module during the second stage such that the energy module is a sole power source for the electric vehicle during the second stage.

The plurality of constraints may include: (1/n) [I_{C}(t)−I_{1,MAX}]≤I_{DC}(t)≤(1/n) [I_{C}(t)−I_{1,MIN}(t)], where t is time, I_{DC} is the DC-DC current, n is a number of phases of the DC-DC current, I_{C} is the charging current, and I_{1,MIN} and I_{1,MAX} are respective minimum and maximum values of the first current. The plurality of constraints may include: [V₂(t)/(n*V₁(t))] [I_{2,MIN}−I_{L}(t)]≤I_{DC}(t)≤[V₂(t)/(n*V₁(t))] [I_{2,MAX}−I_{L}(t)], where t is time, I_{DC} is the DC-DC current, n is a number of phases of the DC-DC current, V₁ and V₂ are respective voltages of the energy module and the power module, I_{L} is a load current transmitted to the load in the vehicle, and I_{2,MIN} and I_{2,MAX} are respective minimum and maximum values of the second current.

The plurality of constraints may include: I_{C}(t)≤I_{1,MAX}, where I_{C} is the charging current, and I_{1,MAX} is a maximum value of the first current. The plurality of constraints may include: ΔI_{C}(t)≤D, where ΔI_{DC} is an incremental change in the DC-DC current over time, and D is a predefined threshold. In one embodiment, the predefined threshold is about 1 Amperes. The DC-DC current may be between about 10 Amperes and 100 Amperes.

Disclosed herein is a method for managing an energy storage device in an electric vehicle having a controller with a processor and tangible, non-transitory memory, the energy storage device having a battery pack. The method includes incorporating an energy module and a power module in the battery pack. The energy module and the power module are connected in parallel. A first current is generated, via the energy module. The method includes adapting at least one DC-to-DC converter to receive the first current from the energy module and transmit a DC-DC current to the power module. The method includes managing a set of parameters related to the battery pack, via the controller, and subjecting the set of parameters to a plurality of constraints. The power module is adapted to deliver a load current for powering a load in the vehicle. The method includes adapting the energy module to selectively recharge the power module with a charging current after a predefined event of relatively high power demand. Operation of the electric vehicle is controlled based in part on the set of parameters, including the DC-DC current, the charging current, a first state of charge defined by the energy module, and a second state of charge defined by the power module.

Disclosed herein is an electric vehicle having a battery pack having an energy module adapted to generate a first current, and a power module connected in parallel to the energy module. At least one DC-to-DC converter is adapted to receive the first current from the energy module and transmit a DC-DC current to the power module. The electric vehicle includes a controller having a processor and tangible, non-transitory memory on which instructions are recorded for automated management of a set of parameters related to the battery pack, subject to a plurality of constraints. The power module is adapted to deliver a second current for powering a load in the vehicle, the energy module being adapted to selectively recharge the power module with a charging current after a predefined event of relatively high power demand. The set of parameters includes the DC-DC current, a first state of charge defined by the energy module, and a second state of charge defined by the power module, operation of the electric vehicle being controlled based in part on the set of parameters.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a system for managing an energy storage device, the system having a controller;

FIG. 2 is a schematic diagram of an example modular architecture employable by the system of FIG. 1;

FIG. 3 is a schematic flow diagram of a method executable by the controller of FIG. 1; and

FIGS. 4A, 4B, 4C, and 4D are schematic example graphs respectively illustrating current, state of charge, voltage, and current transmitted by a DC-to-DC (direct current to direct current) converter, over time for an example energy storage device.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

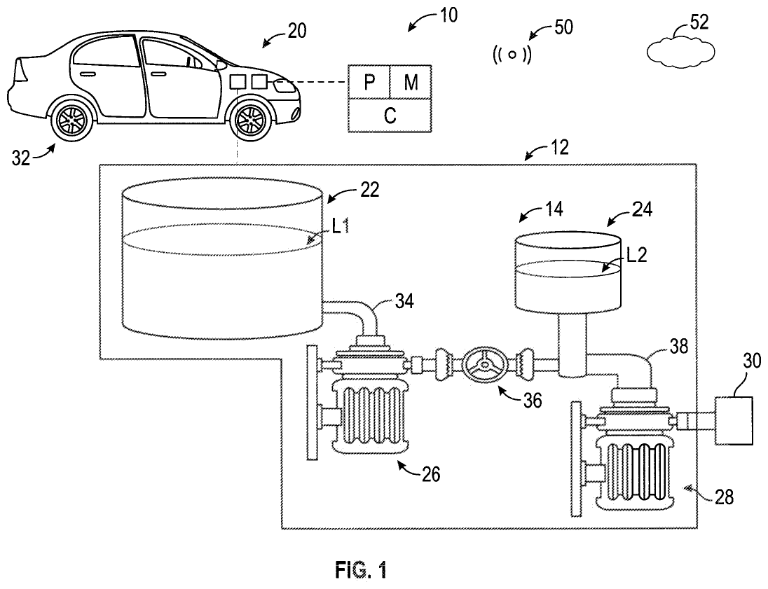

Referring to the drawings, wherein like reference numbers refer to like components, FIG. 1 is a schematic diagram illustrating a system 10 for managing an energy storage device 12. Referring to FIG. 1, the energy storage device 12 may be part of an electric vehicle 20. The electric vehicle 20 may be partially electric or fully electric. The electric vehicle 20 may be a mobile platform, such as, but not limited to, a passenger vehicle, sport utility vehicle, light truck, heavy duty vehicle, ATV, minivan, bus, transit vehicle, bicycle, moving robot, farm implement (e.g., tractor), sports-related equipment (e.g., golf cart), boat, aircraft and train. It is to be understood that the electric vehicle 20 may take many different forms and have additional components.

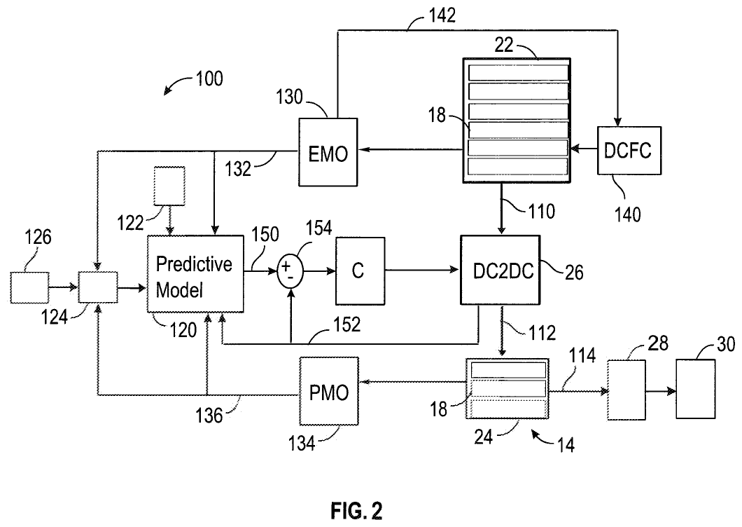

The energy storage device 12 in FIG. 1 is schematically presented as a hydraulic system for illustrative purposes. However, it is to be understood that the energy storage device 12 is a battery system having a battery pack 14. The battery pack 14 features a “dual-design” system in that it employs both energy battery cells and power battery cells. FIG. 2 is a schematic diagram of an example modular architecture 100 employable by the system 10. Referring to FIGS. 1-2, the battery pack 14 includes respective battery cells 18 arranged in an energy module 22 and a power module 24. The power module 24 is parallel to the energy module 22. The power module 24 supplies more power than the energy module 22. The energy module 22 supplies consistent power for a longer duration than the power module 24. The number of respective battery cells 18 in the energy module 22 and power module 24 may be varied based on the application at hand.

The design and/or composition of the power module 24 allows rapid movement of ions into and out of the electrode, thereby generating a higher power output. The design and/or composition of the energy module 22 reduces the movement of ions into and out of the electrode, thereby limiting power output. In other words, the energy module 22 is adapted to provide a sustained current for a longer period compared with the power module 24, and the power module 24 may provide a higher current over a short duration as compared with the energy module 22.

In one embodiment, the respective battery cells 18 in the power module include an electrode formed from a porous material and a thinner coating, while the respective battery cells 18 in the energy module include an electrode formed from a denser material and a thicker coating. In one embodiment, the voltage of the energy module 22 is about 800 volts (V) and the voltage of the power module 24 is between about 400 V to 600 V.

In one embodiment, the energy module 22 and the power module 24 employ batteries based on different chemistries. For example, the energy module 22 may include battery cells with the cathode material composed of nickel, cobalt oxide, and manganese. The power module 24 may include battery cells with the cathode material composed of lithium, iron, and phosphate. It is understood that the system 10 is not tied to a particular cell type, chemistry and configuration of the battery pack 14. In another embodiment, the energy module 22 and the power module 24 employ different battery designs, with the same chemistry.

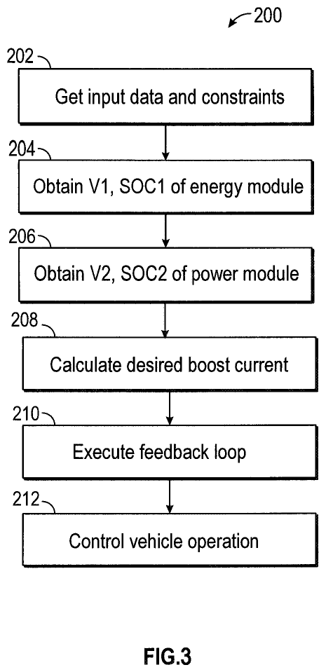

Referring to FIG. 1, the system 10 includes a controller C with at least one processor P and at least one memory M (or non-transitory, tangible computer readable storage medium) on which instructions are recorded for executing a method 200 for managing the battery pack 14, described below with respect to FIG. 3. The memory M can store executable instruction sets, and the processor P can execute the instruction sets stored in the memory M. The method 200 enables automated management of a set of parameters related to the battery pack 14, subject to a plurality of constraints.

Referring to FIGS. 1-2, the energy module 22 is adapted to generate a first current 110. The energy storage device 12 includes at least one direct current to direct current (DC-to-DC) converter 26 adapted to receive the first current 110 (see FIG. 2) from the energy module 22. The DC-to-DC converter 26 is adapted to transmit a current, referred to herein as DC-DC (direct current-direct current) current 112, to the power module 24. The power module 24 is adapted to deliver a second current 114.

Referring to FIGS. 1-2, the power module 24 is adapted to provide on-demand power (via a traction inverter 28) for powering a load, such as an electric motor 30 in the electric vehicle 20. The traction inverter 28 converts the DC power from the battery pack 14 to an AC output for running the electric motor 30. When the electric vehicle 20 is in operation, the battery pack 14 is controlled by the controller C to generate (ultimately) and deliver motor torque to the wheels 32 and thus propel the electric vehicle 20.

The controller C executes a control strategy that maintains full charge of the power module 24 using the DC-to-DC converter 26 after events of relatively high power demand. In other words, the power module 24 is recharged after each event of relatively high power demand, such that the power module 23 is able to fulfill the needs of the vehicle 20 when the next such event occurs. The event of relatively high power demand may be varied based on the application at hand. In one example, the predefined event is the initial acceleration and/or take-off of the electric vehicle 20. The predefined event may include the vehicle 20 being in tow mode and hauling or towing a load. As described below, the controller C manages individual energies from the power module 24 and the energy module 22 to meet power demand while meeting strict constraints in real-time, thereby increasing the life of the battery pack 14 and the DC-to-DC converter 26.

The maximum and minimum current that may be respectively taken from the power module 24 and energy module 22 varies over time as their respective charging status shifts. FIG. 1 schematically indicates the state of charge of the power module 24 and energy module 22 as levels L1 and L2, respectively. The levels L1 and L2 of the power module 24 and energy module 22 should be neither overfilled, nor drained. Referring to FIG. 1, the maximum current flow transmitted by the energy module 22 into the DC-to-DC converter 26 may be limited by a first conduit 34. A user may limit the current flow going into the power module 24 through a selector 36. Similarly, the maximum current flow transmitted by the power module 24 into the traction inverter 28 may be limited by a second conduit 38.

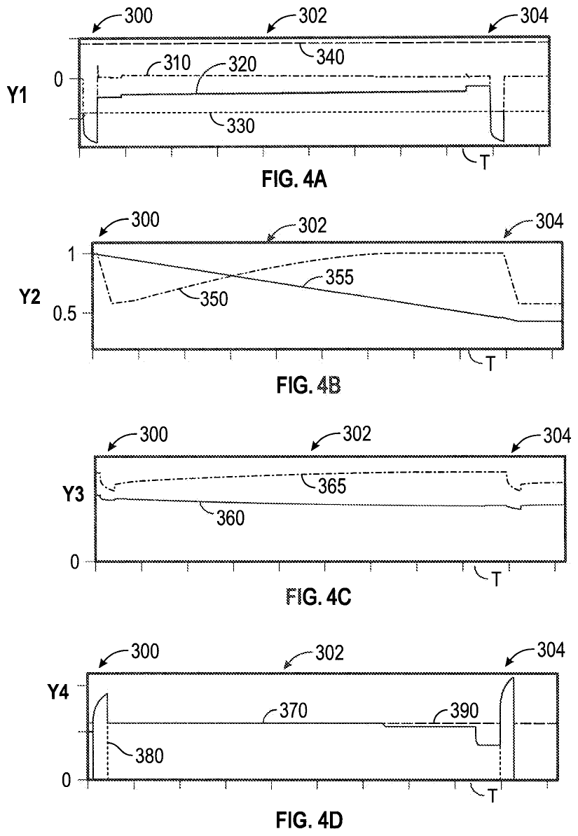

Referring to FIG. 2, the battery pack 14 may be selectively recharged via a DC fast-charging voltage from an off-board DC fast-charging station (DCFC) 140. The desired charging current 142 [I_{C}(t)] may be transmitted to the energy module 22 based on input from the energy module observer 130. The energy module 22 and power module 24 may function concurrently. The DC-DC current is used to modulate the current from the energy module 22 and the power module 24 while fulfilling the load. The direction and the amplitude of the second current 114 from the power module 24 changes over time. As described below with respect to FIG. 4A, in stages 300 and 304, the power module 24 outputs the current (discharging), while in stage 302 the power module 24 is being charged.

Referring now to FIG. 3, a flowchart of the method 200 stored on and executable by the controller C of FIG. 1 is shown. Method 200 may be embodied as computer-readable code or instructions stored on and partially executable by the controller C of FIG. 1. Method 200 need not be applied in the specific order recited herein. Furthermore, it is to be understood that some steps may be eliminated. The method 200 may be dynamically executed.

Per block 202 of FIG. 3, the method 200 includes obtaining input data. Referring to FIG. 2, the modular architecture 100 may include a predictive model 120 that receives input from an input module 122, such as the desired state of charge of the power module 24. The predictive model 120 may receive data from a constraints module 124, including the current throttle demand 126.

Proceeding to block 204, the controller C (via the prediction model 120) is adapted to receive input from an energy module observer (EMO) module 130 which transmits the voltage (V1) and state of charge (SOC1) of the energy module 22 (indicated by signal 132 in FIG. 2). Advancing to block 206, the controller C (via the prediction model 120) is programmed to receive input from a power module observer (PMO) module 134 which transmits the voltage (V2) and the state of charge (SOC2) of the power module 24 (indicated by signal 136 in FIG. 2).

Proceeding to block 208, the controller C (via execution of the predictive model 120) is adapted to calculate a desired DC-DC current 150 (I_{DC}) that satisfies the plurality of constraints (“plurality of” omitted henceforth). The constraints on the desired DC-DC current 150 (I_{DC}) include:

$$( 1 / n ) [ {I}_{C} ( t ) - {I}_{1 , MAX} ] \leq {I}_{DC} ( t ) \leq ( 1 / n ) [ {I}_{C} ( t ) - {I}_{1 , MIN} ( t ) ]$$

Here t is time, I_{DC} is the DC-DC current, n is the number of phases of the DC-DC current, I_{C} is the charging current 142, and I_{1,MIN} and I_{1,MAX} are the respective minimum and maximum values of the first current 110. The constraints on the desired DC-DC current 150 (I_{DC}) include:

$$[ {V}_{2} ( t ) / ( n * {V}_{1} ( t ) ) ] [ {I}_{2 , MIN} - {I}_{L} ( t ) ] \leq {I}_{DC} ( t ) \leq [ {V}_{2} ( t ) / ( n * {V}_{1} ( t ) ) ] [ {I}_{2 , MAX} - {I}_{L} ( t ) ] .$$

Here t is time, I_{DC} is the DC-DC current, n is the number of phases of the DC-DC current, V₁ and V₂ are respective voltages of the energy module 22 and the power module 24, I_{L} is a load current transmitted to the load 30 in the vehicle 20, and I_{2,MIN} and I_{2,MAX} are the respective minimum and maximum values of the second current 114.

The constraints include: I_{C}(t)≤I_{1,MAX}, where I_{C} is the charging current 142, and I_{1,MAX} is a maximum value of the first current 110. The constraints may further include: ΔI_{C}(t)≤D, where ΔI_{DC} is an incremental change in the desired DC-DC current 150 over time, and D is a predefined threshold. In one example, the predefined threshold is about 1 Amperes.

Advancing to block 210, the controller C is programmed to employ closed-loop feedback to minimize a difference (as shown at junction 154) between the desired DC-DC current 150 (calculated by in block 208) and the actual DC-DC current (signal 152) that is being transmitted by the DC-to-DC converter 26. The closed-loop control module available to those skilled in the art may be employed. Proceeding to block 212, operation of the vehicle 20 is controlled based on the set of parameters of the battery pack 14. Controlling operation of the vehicle 20 includes meeting the torque demand of the vehicle 20 through the battery pack 14 while meeting strict constraints in real-time.

Referring now to FIGS. 4A through 4D, schematic example graphs are shown for an example electric vehicle 20. In this example, the electric vehicle 20 is an aircraft that uses electric power from the energy storage device 12, via rotors (not shown), to take off vertically, cruise, and land vertically.

In FIGS. 4A, 4B, 4C, and 4D, the horizontal axis T indicates time. The time period that is shown in FIGS. 4A through 4D is subdivided into a first stage 300, second stage 302, and third stage 304. The first stage 300 is associated with a time period of an initial acceleration mode and/or take-off mode of the electric vehicle 20. The second stage 302 is associated with a driving mode and/or cruising mode of the electric vehicle 20. The third stage 304 is associated with a landing mode or deceleration of the electric vehicle 20. The energy module 22 may be adapted to selectively recharge the power module 24 during the second stage 302 such that the energy module 22 is the sole power source for the battery pack 14 during the second stage 302.

Referring to FIG. 4A, the vertical axis Y1 shows current (in amperes) and the horizontal axis shows time T. Trace 310 shows the second current 114, while trace 320 shows the load current (I_{L}). Traces 330 and 340 are horizontal lines showing the respective minimum and maximum values (I_{2,MIN} and I_{2,MAX}) of the second current 114. The load current (I_{L}) is increased in stage 300 and stage 304. In stages 300 and 304, the power module 24 outputs the current (discharging), while in stage 302 the power module 24 is being charged. In FIG. 4A, the negative current represents discharging, while the positive current represents charging.

Referring to FIG. 4B, the vertical axis Y2 indicates state of charge, while the horizontal axis shows time T. Trace 350 shows the state of charge (SOC1) of the energy module 22, while trace 355 shows the state of charge (SOC2) of the power module 24. As shown by trace 355 in FIG. 4B, the state of charge (SOC1) for the energy module continuously declines during each of the first, second and third stages 300, 302, 304. As shown by trace 350, the state of charge (SOC2) for the power module shows a sharp decline in the first stage 300, then increases during the second stage 302 as it is being charged by the energy module 22, finally showing a steep decline in the third stage 304 when both the energy module 22 and the power module 24 supply power to the load 30.

Referring to FIG. 4C, the vertical axis Y3 indicates voltage, while the horizontal axis shows time T. Trace 360 shows the voltage (V1) of the energy module 22, while trace 365 shows the voltage (V2) of the power module 24. As shown by traces 360, 365, the respective voltages V1, V2 are relatively constant during the second stage 302, and both show a slight dip during the first stage 300, and the third stage 304, the difference being as result of smaller capacity.

Referring to FIG. 4D, the vertical axis Y4 indicates the DC-DC current, while the horizontal axis shows time T. Traces 370, 380, 390 respectively show the DC-DC current, a predefined minimum DC-DC current and predefined maximum DC-DC current. The minimum and maximum DC-DC current may be adjusted for optimal results. As shown by trace 370, the DC-DC current shows a sharp increase during the first stage 300, is relatively constant during the second stage 302, and shows a dip just before the third stage 304.

Referring to FIG. 1, the controller C may be configured to receive and transmit wireless communication with a cloud unit 52, via the wireless network 50. The cloud unit 52 may include one or more servers hosted on the Internet to store, manage, and process data. The wireless network 50 of FIG. 1 may be a Wireless Local Area Network (LAN), a Wireless Metropolitan Area Networks (MAN), a Wireless Wide Area Network (WAN), WIFI, or Bluetooth™ connection.

In summary, the system 10 allows generation of real-time constraints for using a battery model and predicting current limits of the energy module 22 and the power module 24. The respective battery cells 18 in the energy module 22 generally deliver sustained and continuous current over a long duration, while the respective battery cells 18 in the power module 24 generally deliver high current loads over a short duration at intermittent intervals. The system 10 allows for selective adjustment of the charge level of the power module 24. The DC-DC converter 26 allows charging of the power module 24 by the energy module 22.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 may be an integral portion of, or a separate module operatively connected to, other controllers of the electric vehicle 20. The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database energy system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts shown in the FIG(S). illustrate an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for managing an energy storage device in an electric vehicle, the system comprising:
a battery pack having an energy module adapted to generate a first current, and a power module connected in parallel to the energy module;
at least one DC-to-DC (direct current to direct current) converter adapted to receive the first current from the energy module, and transmit a DC-DC (direct current-direct current) current to the power module;
a controller having a processor and tangible, non-transitory memory on which instructions are recorded for automated management of a set of parameters related to the battery pack, subject to a plurality of constraints;
wherein the power module is adapted to deliver a second current, the energy module being adapted to selectively recharge the power module with a charging current after a predefined event of relatively high power demand; and
wherein the set of parameters includes the DC-DC current, the charging current, a first state of charge defined by the energy module, and a second state of charge defined by the power module, operation of the electric vehicle being controlled based in part on the set of parameters.

2. The system of claim 1, wherein the energy module and the power module have different chemistries.

3. The system of claim 2, wherein:
the energy module includes respective battery cells composed of nickel, cobalt oxide, and manganese; and
the power module includes the respective battery cells composed of lithium, iron, and phosphate.

4. The system of claim 2, wherein:
the electric vehicle is adapted to undergo a first stage and a second stage, the first stage being associated with an initial acceleration mode and/or take-off mode of the vehicle, the second stage being associated with a driving mode and/or cruising mode of the vehicle; and
the energy module is adapted to recharge the power module during the second stage such that the energy module is a sole power source for the electric vehicle during the second stage.

5. The system of claim 1, wherein the plurality of constraints includes: (1/n) [I_{C}(t)−I_{1,MAX}]≤I_{DC}(t)≤(1/n) [I_{C}(t)−I_{1,MIN}(t)], where t is time, I_{DC} is the DC-DC current, n is a number of phases of the DC-DC current, I_{C} is the charging current, and I_{1,MIN} and I_{1,MAX} are respective minimum and maximum values of the first current.

6. The system of claim 1, wherein the plurality of constraints includes: [V₂(t)/(n*V₁(t))] [I_{2,MIN}−I_{L}(t)]I_{DC}(t)≤[V₂(t)/(n*V₁(t))] [I_{2,MAX}−I_{L}(t)], where t is time, I_{DC} is the DC-DC current, n is a number of phases of the DC-DC current, V₁ and V₂ are respective voltages of the energy module and the power module, I_{L} is a load current transmitted to the load in the vehicle, and I_{2,MIN} and I_{2,MAX} are respective minimum and maximum values of the second current.

7. The system of claim 6, wherein the plurality of constraints includes: I_{C}(t)≤I_{1,MAX}, where I_{C} is the charging current, and I_{1,MAX} is a maximum value of the first current.

8. The system of claim 7, wherein the plurality of constraints includes: ΔI_{C}(t)≤D, where ΔI_{DC} is an incremental change in the DC-DC current over time, and D is a predefined threshold.

9. The system of claim 8, wherein the predefined threshold is about 1 Amperes.

10. The system of claim 1, wherein the DC-DC current is between about 10 Amperes and 100 Amperes.

11. A method for managing an energy storage device in an electric vehicle having a controller with a processor and tangible, non-transitory memory, the energy storage device having a battery pack, the method comprising:
incorporating an energy module and a power module in the battery pack, the energy module and the power module being connected in parallel;
generating a first current, via the energy module;
adapting at least one DC-to-DC (direct current to direct current) converter to receive the first current from the energy module, and transmit a DC-DC (direct current-direct current) current to the power module;
managing a set of parameters related to the battery pack, via the controller, and subjecting the set of parameters to a plurality of constraints;
adapting the power module to deliver a load current for powering a load in the vehicle;
adapting the energy module to selectively recharge the power module with a charging current after a predefined event of relatively high power demand; and
controlling operation of the electric vehicle based in part on the set of parameters, including the DC-DC current, the charging current, a first state of charge defined by the energy module, and a second state of charge defined by the power module.

12. The method of claim 11, further comprising:
incorporating respective battery cells composed of nickel, cobalt oxide, and manganese in the energy module; and
incorporating the respective battery cells composed of lithium, iron, and phosphate in the power module.

13. The method of claim 11, further comprising:
setting the plurality of constraints to include: (1/n) [I_{C}(t)−I_{1,MAX}]≤I_{DC}(t)≤(1/n) [I_{C}(t)−I_{1,MIN}(t)], where t is time, I_{DC} is the DC-DC current, n is a number of phases of the DC-DC current, I_{C} is the charging current, and I_{1,MIN} and I_{1,MAX} are respective minimum and maximum values of the first current.

14. The method of claim 11, further comprising:
setting the plurality of constraints to include: [V₂(t)/(n*V₁(t))] [I_{2,MIN}−I_{L}(t)]≤I_{DC}(t)≤[V₂(t)/(n*V₁(t))] [I_{2,MAX}−I_{L}(t)], where t is time, I_{DC} is the DC-DC current, n is a number of phases of the DC-DC current, V₁ and V₂ are respective voltages of the energy module and the power module, I_{L} is a load current transmitted to the load in the electric vehicle, and I_{2,MIN} and I_{2,MAX} are respective minimum and maximum values of the second current.

15. An electric vehicle comprising:
a battery pack having an energy module adapted to generate a first current, and a power module connected in parallel to the energy module;
at least one DC-to-DC (direct current to direct current) converter adapted to receive the first current from the energy module, and transmit a DC-DC (direct current-direct current) current to the power module;
a controller having a processor and tangible, non-transitory memory on which instructions are recorded for automated management of a set of parameters related to the battery pack, subject to a plurality of constraints;
wherein the power module is adapted to deliver a second current for powering a load in the vehicle, the energy module being adapted to selectively recharge the power module with a charging current after a predefined event of relatively high power demand; and
wherein the set of parameters includes the DC-DC current, a first state of charge defined by the energy module, and a second state of charge defined by the power module, operation of the electric vehicle being controlled based in part on the set of parameters.

16. The electric vehicle of claim 15, wherein the energy module and the power module have different chemistries.

17. The electric vehicle of claim 16, wherein:
the energy module includes respective battery cells composed of nickel, cobalt oxide, and manganese; and
the power module includes the respective battery cells composed of lithium, iron, and phosphate.

18. The electric vehicle of claim 16, wherein the plurality of constraints includes: (1/n) [I_{C}(t)−I_{1,MAX}]I_{DC}(t)≤(1/n) [I_{C}(t)−I_{1,MIN}(t)], where t is time, I_{DC} is the DC-DC current, n is a number of phases of the DC-DC current, I_{C} is the charging current, and I_{1,MIN} and I_{1,MAX} are respective minimum and maximum values of the first current.

19. The electric vehicle of claim 18, wherein the plurality of constraints includes: [V₂(t)/(n*V₁(t))] [I_{2,MIN}−I_{L}(t)]≤I_{DC}(t)≤[V₂(t)/(n*V₁(t))] [I_{2,MAX}−I_{L}(t)], where t is time, I_{DC} is the DC-DC current, n is a number of phases of the DC-DC current, V₁ is a respective voltage of the energy module, V₁ and V₂ are respective voltages of the energy module and the power module, I_{L} is a load current transmitted to the load in the vehicle, and I_{2,MIN} and I_{2,MAX} are respective minimum and maximum values of the second current.

20. The electric vehicle of claim 19, wherein the plurality of constraints includes: I_{C}(t)≤I_{1,MAX}, where I_{C} is the charging current and I_{1,MAX} is a maximum value of the first current.
